(19) United States
(12) Patent Application Publication
(10) Pub. No.: US 2003/0197379 A1
(43) Pub. Date: Oct. 23, 2003

(54) Multi-sealing compression fitting for plumbing connections

(76) Inventor: Donald S. Glover, Birmingham, MI (US)

Correspondence Address: Edgar A. Zarins, Masco Corporation, 21001 Van Born Road, Taylor, MI, 48180, US

(21) Appl. No.: 10/315,570

(22) Filed: Dec. 10, 2002

Related U.S. Application Data
(60) Provisional application No. 60/373,529, filed on Apr. 18, 2002.

(51) Int. Cl. F16L 17/00

(52) U.S. Cl. 285/342

(57) ABSTRACT

A compression fitting for sealingly connecting a fluid line to a valve, connector or other fixture. The fitting includes a seat for receiving the end of the fluid tubing. A compression nut coaxially mounted to the tubing threadably engages the fitting to create a compression engagement with the tubing and sealingly connect the fluid line to the fitting for directing fluid flow therethrough. The compression nut includes an inner annular groove for receiving a seal member. The seal member extends into the throughbore of the compression nut to form a secondary seal against the fitting.

### RELATED APPLICATIONS

This application claims priority from U.S. Provisional Application No. 60/373,529 filed on Apr. 18, 2002.

### BACKGROUND OF THE INVENTION

I. Field of the Invention

The present invention is directed to a compression fitting for connecting sections of fluid tubing to valves, connectors or additional lengths of tubing and, in particular, to a compression fitting with multiple sealing points to improve sealing connection of the components.

II. Description of the Prior Art

Compression fittings have become a convenient device for connecting valves, splitters, connectors and new fluid lines without the need for specialized tools. With the increased utilization of flexible plastic material such as PEX and CPVC in plumbing fluid lines, compression couplings permit the do-it-yourselfer to run new plumbing or to repair existing lines. Traditionally, copper or other metal tubing was used to deliver water to a desired fixture. Connectors and valves are sometimes fixedly connected or may need to be “sweated” using a torch and solder which is an art in itself. Compression couplings eliminate the need for specialized tools or skills.

The prior known compression couplings generally included a body with a seat corresponding to the outer diameter of the pipe being used. The pipe is inserted into the seat to provide fluid communication with the throughbore of the coupling body. A compression nut and compression ring, each having an axial throughbore, are coaxially mounted to the tubing. The compression nut is adapted to threadably engage the coupling body simultaneously placing the ring into compression against the tubing. This compressive engagement is intended to both seal against the outer surface of the tubing while gripping the tubing to prevent the pipe from backing out of its seat.

The limitations of the conventional compression coupling can cause improper installation and possible fluid leakage. Often the compression rings do not adequately retain the tubing in position as the nut is tightened. Still another disadvantage is that the compression rings can rotate off of their axis resulting in leakage due to misalignment of the ring on the tubing. Due to the nature of the different tubing material properties, i.e. copper, PEX and CPVC, each type of tubing has had its own system of securing and sealing within the respective fitting. It is desirable to have an inexpensive coupling assembly which is easily installed and assures that the tubing when secured therein has a reduced possibility of leakage.

### SUMMARY OF THE PRESENT INVENTION

The present invention overcomes the disadvantages of the prior known compression fittings by utilizing internal geometry to ensure a secure gripping action and provide a secondary seal element to prevent leakage through the fitting.

A compression fitting according to the present invention may be utilized in conjunction with a variety of plumbing assemblies to connect a water line to the assembly. Some examples of such plumbing assemblies include valves, connectors, diverters or tees, and plumbing fixtures. The plumbing assembly will include a body having at least one seat having an inner diameter closely corresponding to the outer diameter of the fluid tubing to be used therewith. The seat has an end wall against which the end of the tubing abuts. The end wall includes a throughbore to direct fluid from the tubing through the plumbing assembly. An exterior surface of the assembly includes threads for threadably engaging a compression nut. The compression nut has a throughbore for receiving the fluid tubing and a hex exterior for manipulation on the assembly.

The configuration of the interior of both the compression nut and the fitting facilitate a secure, sealing engagement of the flexible tubing. In one embodiment of the invention, the compression nut includes a square seat which receives a compression ring having an interior end which tapers in thickness to form a wedge-like interior edge. The exterior end of the compression ring has a square edge to fit within the square seat of the compression nut thereby eliminating misalignment of ring within the compression nut. As the compression nut is tightened on the fitting, the compression ring will engage a chamfered edge of the fitting and be wedged radially inwardly against the tubing to prevent withdrawal of the tubing from fitting.

In order to provide secondary sealing capability, the compression nut in these embodiments of the compression coupling includes a captured O-ring to seal against the exterior of the fluid line. An annular groove is machined within the inner surface of the compression nut proximate the head or exterior end of the compression nut. A seal member is positioned within the groove to extend partially into the throughbore of the compression nut. In this manner, fluid tubing passing through the compression nut into the fitting will be sealingly engaged by the O-ring. Seating of the end of the tubing within the fitting by the compression structure acts as the primary seal and the O-ring engaging the tubing acts as the secondary seal for the compression coupling of the present invention.

The compression coupling of the present invention is designed to secure copper, PEX or CPVC tubing to an industry standard compression fitting or valve. The coupling of this invention is also capable of accommodating copper tubing of various wall thicknesses and tempers. The coupling is preferably delivered to the end user fully assembled and hand tightened to the fitting or valve body. The user will slip the tubing through the compression nut and ring into the seat passing through the O-ring seal. The end user can then simply tighten the nut to provide adequate retention of the tubing. The coupling is engineered to drive the compression ring into the fitting, collapse around the tubing and provide a primary seal. The O-ring provides a secondary seal should the primary compression ring seal fail due to expected thermal expansion, creep, compression set, etc of the assembly.

Other objects, features and advantages of the invention will be apparent from the following detailed description taken in connection with the accompanying drawings.

### BRIEF DESCRIPTION OF THE DRAWING

The present invention will be more fully understood by reference to the following detailed description of a preferred embodiment of the present invention when read in conjunction with the accompanying drawing, in which like reference characters refer to like parts throughout the view and in which:

FIG. 1 is an exploded view of a sample plumbing fitting embodying the compression coupling of the present invention;

FIG. 2 is a cross-sectional view thereof;

FIG. 3 is an enlarged partial cross-sectional view thereof; and

FIG. 4 is a cross-sectional view of the compression nut.

### DETAILED DESCRIPTION OF A PREFERRED EMBODIMENT OF THE PRESENT INVENTION

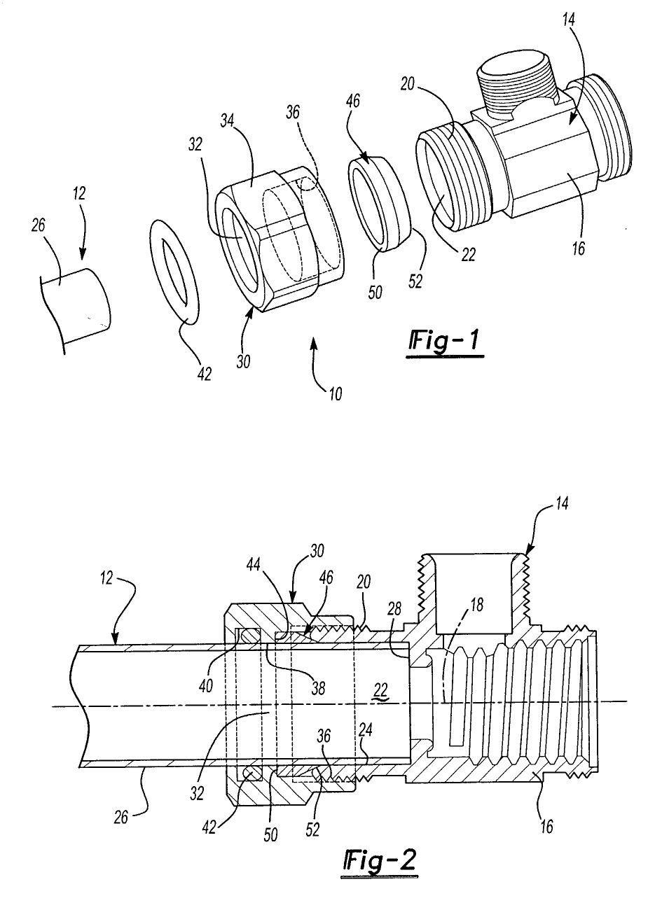

Referring first to FIG. 1, there is shown a compression assembly 10 for mechanically and sealingly connecting a fluid line such as tubing 12 to a plumbing fitting 14. The compression assembly 10 may be used in connection with a variety of fittings 14 including valves, connectors and other plumbing fixtures. The compression assembly 10 of the present invention facilitates connection or expansion of plumbing systems without the need for specialized tools or skills.

Referring now to FIGS. 1 through 3, the fitting 14 generally comprises a body 16 having at least one fluid passageway 18. Formed on the exterior of the body 16 are standardized threads 20 for connection of the compression assembly 10. Forming a part of the fluid passageway 18 of the fitting 14 is a pocket 22 with an inner diameter 24 corresponding closely to an outer diameter 26 of the tubing 12 in order to snugly receive the tubing 12 upon insertion within the pocket 22 as best shown in FIG. 2. The pocket 22 includes an end wall 28 which limits the extent the tubing 12 can be inserted into the fitting 14. Properly sized and inserted, the tubing 12 will abut the end wall 28 and will be matingly received within the pocket 22 as shown in FIG. 2. In this manner, fluid flow from the tubing 12 will be directed through the fluid passageway of the fitting 14.

Mounted coaxially to the tubing 12 is a compression nut 30 having an axial throughbore 32 through which the tubing 12 extends. Preferably, the compression nut 30 has a hexagonal outer configuration 34 to facilitate manipulation and inner threads 36 corresponding to the exterior threads 20 of the fitting 14.

Formed proximate an exterior end of the compression nut 30 in an inner surface 38 is an annular groove 40. Seated within the groove 40 is a seal member 42, preferably a rubber O-ring seal 42. The seal member 42 is sized such that when seated in the groove 40, the seal 42 extends partially into the passageway 32 to sealingly engage the tubing 12 to operate as a secondary seal as will be subsequently described. Although a conventional O-ring seal 42 is described, the seal member 42 may be of any known configuration or material with sealing properties.

Also formed in the inner surface of the compression nut 30 is a shoulder 44 creating an annular space within the nut 30. Disposed within the annular space formed by the shoulder 44 is a compression ring 46. In one embodiment of the present invention, the shoulder 44 forms a square seat 48 and exterior end 50 of the ring 46 has a square configuration. As a result, unlike prior known compression rings which tend to pivot out of position, the ring 46 of the present invention will seat squarely against the shoulder 44 facilitating insertion of the tubing 12 through the compression nut 30 and ring 46. An interior end 52 of the compression ring 46 has a tapered thickness forming a wedge-like end 52. The reduced material thickness also allows the compression ring 46 to bend under the compressive forces of the connector 10.

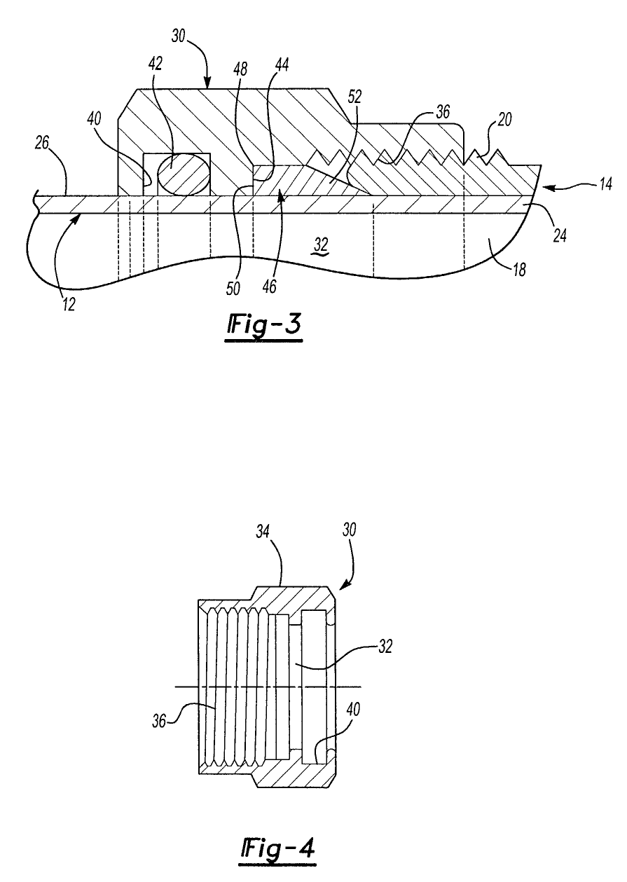

The compression assembly 10 of the present invention is constructed to be supplied to the user pre-assembled such that the tubing 12 can simply be inserted through the compression nut 30 and the compression ring 46 into the pocket 22 of the fitting 14. Prior known compression assemblies required that the compression nut and ring be slipped onto the tubing 12 prior to insertion into the fitting 14. The compression assembly 10 of the present invention is preassembled by inserting the seal 42 in the inner annular groove 40 of the compression nut 30 and seating the compression ring 46 within the seat 48. The compression nut 30 can then be threadably attached to the fitting 14 until the compression ring 46 is captured between the shoulder 44 and the end of fitting 14 as shown in FIGS. 2 and 3.

Assembly of the connection is completed by inserting the tubing 12, into the fitting 14 until the end of the tubing 12 abuts the end wall 28 of the pocket 22. The compression nut 30 can now be tightened, pushing the compression ring 46 against the end of the fitting 14. As the wedge-like end 52 of the ring 46 engages the fitting 14, it will be forced radially inwardly against the tubing 12, “grabbing” the tubing 12 and creating a primary seal within the compressed fitting 10. The seal member 42 engages the outer surface 26 of tubing 12 across its periphery forming a secondary seal in the event improper installation or changes in material properties causes the primary seal to leak.

The compression coupling of the present invention is designed to secure copper, PEX or CPVC tubing to an industry standard compression fitting or valve. The coupling is particularly useful in securing copper tube of different wall thicknesses and tempers. The coupling is delivered to the end user fully assembled and hand tightened to the fitting or valve body. The user will slip the tubing through the compression nut and ring into the seat passing through the O-ring seal. The end user can then simply tighten the nut to provide adequate retention of the tubing. The coupling is engineered to drive the compression ring into the fitting, collapse around the tubing and provide a primary seal. The O-ring provides a secondary seal should the primary compression ring seal fail due to dimensional changes to the tubing.

The foregoing detailed description has been given for clearness of understanding and no unnecessary limitations should be understood therefrom as some modifications will be obvious to those skilled in the art without departing from the scope and spirit of the appended claims.

What is claimed is:

1. A fluid line coupling comprising:
a fluid device having a body with an internal fluid passageway and a pocket in communication with said fluid passageway, said pocket sized to receive the fluid line;
a fastener member threadably engaging said fluid device, said fastener member having a throughbore forming an inner surface sized to receive the fluid line;
a primary sealing member made from a deformable material, said primary sealing member sized to receive the fluid line and said primary sealing member disposed within said body of said fluid device wherein upon tightening of said fastener member said primary sealing member engages said body of said fluid device and is deformed radially inwardly to engage the fluid line; and
a secondary sealing member carried by said fastener member, said secondary sealing member extending into said throughbore to sealingly engage the fluid line extending through said fastener member.

2. The coupling as defined in claim 1 wherein said secondary sealing member is an elastomeric seal captured within an annular groove formed in an inner surface of said fastener member.

3. The coupling as defined in claim 2 wherein said annular groove is formed proximate an exterior end of said fastener member distal from said fluid device.

4. The coupling as defined in claim 3 wherein said elastomeric seal is an O-ring positioned within said annular groove.

5. The coupling as defined in claim 2 wherein said primary sealing member is a compression ring positionally captured within said fastener member and coaxially mounted to the fluid line.

6. The coupling as defined in claim 5 wherein said fastener member includes an internal shoulder forming a seat and said compression ring has an edge positioned within said seat.

7. The coupling as defined in claim 6 wherein said compression ring has a substantially square edge received within a square seat formed by said shoulder.

8. The coupling as defined in claim 6 wherein said compression ring includes a tapered edge deformable into sealing engagement with the fluid line.

9. A fluid line coupling comprising:
a fluid device having a body with an internal fluid passageway and a pocket in communication with said fluid passageway, said pocket sized to receive the fluid line;
a fastener member threadably engaging said fluid device, said fastener member having a throughbore forming an inner surface sized to receive the fluid line, said fastener having an annular groove formed within said inner surface and open to said throughbore;
a primary seating member made of a deformable material, said primary sealing member seated within said fastener member and sized to receive the fluid line wherein upon tightening of said fastener member on said fluid device said primary sealing member engages said body of said fluid device and is deformed radially inwardly to engage the fluid line;
a secondary sealing member disposed within said annular groove of said fastener member, said secondary sealing member extending into said throughbore to sealingly engage the fluid line extending through said fastener member.

10. The coupling as defined in claim 9 wherein said secondary sealing member is an elastomeric seal captured within an annular groove formed in an inner surface of said fastener member.

11. The coupling as defined in claim 10 wherein said annular groove is formed proximate an exterior end of said fastener member distal from said fluid device.

12. The coupling as defined in claim 11 wherein said elastomeric seal is an O-ring positioned within said annular groove.

13. The coupling as defined in claim 10 wherein said primary sealing member is a compression ring positionally captured within said fastener member and coaxially mounted to the fluid line.

14. The coupling as defined in claim 11 wherein said fastener member includes an internal shoulder forming a seat and said compression ring has an edge positioned within said seat.

15. The coupling as defined in claim 14 wherein said compression ring has a substantially square edge received within a square set formed by said shoulder.

16. The coupling as defined in claim 14 wherein said compression ring includes a tapered edge deformable into sealing engagement with the fluid line.
